(19) United States
(12) Patent Application Publication
(10) Pub. No.: US 2025/0368128 A1
(43) Pub. Date: Dec. 4, 2025

(54) SHAPED PART AND METHOD FOR PRODUCING A SHAPED PART

(71) Applicant: NOVEM CAR INTERIOR DESIGN GMBH, Vorbach (DE)

(72) Inventors: Manuel ZAPF, Eckersdorf (DE); Gabriel SCHABORAK, Bayreuth (DE)

(21) Appl. No.: 18/002,146

(22) PCT Filed: Jun. 18, 2021
(86) PCT No.: PCT/EP2021/066570

§ 371 Date: Dec. 16, 2022

(30) Foreign Application Priority Data
Jun. 18, 2020 (DE) 10 2020 116 110.7

(51) Int. Cl. B60Q 3/62; B29C 45/14; B29C 45/26; B29L 31/30; B60Q 3/54; B60R 13/02

(52) U.S. Cl. CPC B60Q 3/62; B29C 45/14336; B29C 45/26; B29C 2045/14868; B29K 2995/0026; B29K 2995/0029; B29L 2031/3041; B60Q 3/54; B60R 13/02

(57) ABSTRACT

A shaped part (10) comprising a decorative layer (12), a transparent or translucent substrate (15) located on the rear face (13) of the decorative layer (12), and at least one light source (18), wherein the substrate (15) has recesses (19) in its front face (16), wherein the decorative layer (12) has a number of break portions (22) corresponding to the number of recesses (19), wherein each break portion (22) is broken out of the decorative layer (12) in the direction of the substrate (15) along provided breaking edges (23), and one break portion (22) is located on the bottom face (20) of each recess (19) so that the at least one lateral face (21) of each recess (19) is exposed and forms a part of the shaped-part front face (11), and wherein light (L) emanating from the light source (18) shines through the transparent or translucent substrate (15) and is coupled out of the lateral face or lateral faces (21) of the one or more recesses (19) for illuminating the front face (13) of the decorative layer (12).

The invention relates to a shaped part, in particular to a decorative and/or lining part for the interior of a vehicle, and to a method for producing a shaped part, in particular a shaped part according to the invention.

Numerous decorative and panel parts are installed in the vehicle interior, for example door panels, console panels, and instrument panels. The decorative and panel parts also include control buttons and their covers.

The demands on such shaped parts are constantly increasing; in particular there is a need for shaped parts with which diverse optical effects can be realized on the visible face of the shaped part.

The invention is therefore based on the object of specifying a novel shaped part and a novel method for producing a shaped part, in particular a shaped part and a novel method for producing a shaped part in which optical effects can be realized on the visible face of the shaped part.

This object is achieved in terms of the shaped part by the features of claim 1 and in terms of the method by the features of claim 7. Advantageous embodiments and developments are provided in each of the dependent claims.

The shaped part according to the invention, in particular a decorative and/or lining part for the vehicle interior, has a shaped-part front face designed as a visible face. The shaped part according to the invention comprises a decorative layer having a front face and a rear face opposite the front face, a transparent or translucent substrate located on the rear face of the decorative layer, preferably made of polycarbonate (PC), the substrate having a front face and a rear face opposite the front face, and at least one light source located laterally on or at the rear face of the substrate for shining through the substrate and/or for illuminating at least a part of the front face of the decorative layer.

The substrate has one or more recesses on its front face, wherein each recess has a bottom face and at least one lateral face, wherein the decorative layer has a number of break portions corresponding to the number of recesses, wherein each break portion is at least partially broken out of the decorative layer in the direction of the substrate along provided breaking edges, and one break portion is located on the bottom face of each recess so that the at least one lateral face of each recess is exposed and forms a part of the shaped-part front face, and wherein light emanating from the light source shines through the transparent or translucent substrate and is coupled out of the lateral face or lateral faces of the one or more recesses to illuminate the front face of the decorative layer.

The advantages of the invention are, in particular, that the shaped part according to the invention can be used to produce patterns on the visible face of the shaped part, which create three-dimensional effects for the observer due to the inventive structure of the shaped part.

According to a development of the invention, it is provided that each break portion has at least one breaking edge, preferably two breaking edges, each breaking edge completely severing the decorative layer.

A plurality of recesses and a corresponding number of break portions are preferably provided, the recesses and/or break portions forming a pattern on the front face of the decorative layer.

It can be provided that the decorative layer is made of wood and/or wood veneer and/or stone and/or metal, preferably aluminum, and/or plastics material, or that the decorative layer is made of wood and/or wood veneer and/or stone and/or metal, preferably aluminum, and/or plastics material. The decorative layer may be opaque as well as translucent at least in portions.

According to one embodiment of the invention, the light source is or comprises a flat or partially flat light element, the light element extending at least in portions, preferably completely, over the rear face of the substrate. The light source can also be located laterally on the substrate. If the light source is located laterally on the substrate, the substrate forms a light guide for the light emanating from the light source.

A light barrier can be provided on the rear face of the decorative layer, the light barrier preferably being an adhesive or lacquer, in particular a black adhesive or lacquer, or comprising an adhesive or lacquer, in particular a black adhesive or lacquer, which is applied to the rear face of the decorative layer. Furthermore, it can be provided that the light barrier comprises both an adhesive and a lacquer, the lacquer being applied to the rear face of the decorative layer and the adhesive being provided on the lacquered rear face of the decorative layer. An advantage of the light barrier is that no stray light shines through a partially translucent decorative layer. For example, in the case of wood veneer as a decorative layer, the growth rings can form translucent regions.

Alternatively or additionally, a transparent or translucent protective and/or optical layer, in particular made of open-pored or high-gloss lacquer, can be located on the front face of the decorative layer. The protective and/or optical layer is preferably formed from polyurethane (PUR) which is preferably cast on. It can be provided that the protective and/or optical layer is located on the front face of the decorative layer in such a way that the shaped-part front face is designed to be flat or smooth.

The protective and/or optical layer can form a light guide, wherein light coupled out of the lateral face(s) of the one or more recesses is coupled into the protective and/or optical layer designed as a light guide, so that the shaped-part front face is preferably flooded with light over its entire surface by means of this light guide.

The method according to the invention for producing a shaped part, in particular a shaped part according to the invention, comprises the steps of:
providing a decorative material intended to form the decorative layer;
creating breaking edges in the decorative layer;
providing an injection mold, comprising at least a first mold half and a second mold half as well as a cavity formed by the two mold halves, wherein an insert having a negative structure with respect to one or more recesses to be formed in the substrate is located on the first mold half, or wherein the first mold half has a mold face with a negative structure with respect to one or more recesses to be formed in the substrate;
inserting the decorative material provided for forming the decorative layer into the injection mold in such a way that the front face of the decorative material provided for forming the decorative layer is oriented toward the first mold half;
closing the injection mold;
injecting a transparent or translucent substrate material, in particular plastics material, preferably polycarbonate (PC), to form the substrate from the second mold half onto the rear face of the decorative material provided for forming the decorative layer,
wherein the front face of the decorative material provided for forming the decorative layer is pressed against the insert or the mold face of the first mold half and the decorative layer of the shaped part is thus formed in a shape specified by the insert and/or the mold face of the first mold half, and
wherein the decorative material provided for forming the decorative layer is broken at the breaking edges by the negative structure of the insert or the mold face of the first mold half in such a way that break portions are formed in the decorative layer, wherein each break portion is at least partially broken out of the decorative layer in the direction of the substrate to be formed,
wherein a recess is formed by the negative structure of the insert or the mold face of the first mold half on the front face of the substrate in the region of each break portion, each recess having a bottom face and at least one lateral face,
wherein one break portion is located on the bottom face of each recess due to the negative structure of the insert or the mold face of the first mold half, so that the at least one lateral face of each recess is exposed and forms a part of the shaped-part front face;
solidifying the substrate material and removing the substrate-decorative layer composite from the injection mold;
locating a light source for shining through the substrate and/or for illuminating at least part of the front face of the decorative layer laterally on the substrate or on the rear face of the substrate.

According to one embodiment of the method according to the invention, it can be provided that the breaking edges are produced by means of an embossing plate before injection molding, in particular embossed, in the decorative material provided for forming the decorative layer, wherein the decorative material provided for forming the decorative layer is preferably completely severed.

It can also be provided that the embossing plate is used as an insert for the injection mold after the breaking edges have been produced.

Alternatively, it can be provided that the breaking edges are produced, in particular embossed, by the insert, in particular an embossing plate provided as an insert, or by the mold face of the first mold half during injection molding in the decorative material provided for forming the decorative layer, wherein the decorative material provided for forming the decorative layer is preferably completely severed.

It can thus be provided that the breaking edges are introduced into the decorative material provided for forming the decorative layer before injection molding, for example by means of an embossing plate. Alternatively, however, the breaking edges can also be produced during injection molding, for example by the high pressure when injecting the substrate material. The choice of method depends in particular on the geometry of the breaking edges and/or on the decorative material provided for forming the decorative layer.

A plurality of recesses and a corresponding number of break portions are preferably provided, the recesses and/or break portions forming an intended pattern on the front face of the decorative layer.

Furthermore, a light barrier can be provided on the rear face of the decorative layer. An adhesive or lacquer, in particular a black adhesive or lacquer, is preferably used as a light barrier, which is applied to the rear face of the decorative layer. Furthermore, it can be provided that the light barrier comprises both an adhesive and a lacquer, the lacquer being applied to the rear face of the decorative layer and the adhesive then being provided on the lacquered rear face of the decorative layer.

Alternatively or additionally, a protective and/or optical layer, in particular made of open-pored or high-gloss lacquer, can be located on the front face of the decorative layer after the substrate-decorative layer composite has been produced. The protective and/or optical layer is preferably formed from polyurethane (PUR), particularly preferably for forming the high-gloss variant. The PUR is preferably poured onto the front face of the decorative layer. It can be provided that the protective and/or optical layer is poured onto the front face of the decorative layer in such a way that the shaped-part front face is flat or smooth, in particular by filling the recesses with the PUR. Before the PUR is poured on, an insulating and/or primer layer is preferably provided on the front face of the decorative layer.

It can be provided that wood and/or wood veneer and/or stone and/or metal, preferably aluminum, and/or plastics material is used as the decorative material provided for forming the decorative layer.

Furthermore, it can be provided that a flat or partially flat light element is used as the light source, the light element preferably extending at least in portions, preferably completely, over the rear face of the substrate. The light element can also be located laterally on the substrate.

The invention is explained in more detail below also with regard to further features and advantages on the basis of the description of embodiments and with reference to the accompanying schematic drawings, in which:

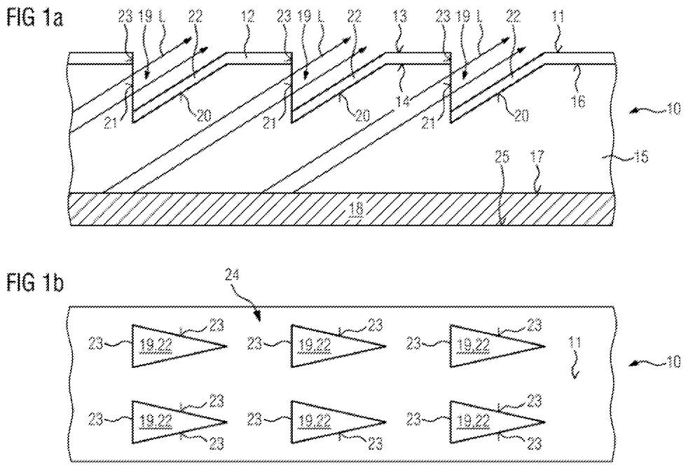

FIG. 1a is a schematic sectional view of a detail of the shaped part according to the invention viewed from the side;

FIG. 1b is a schematic plan view of a detail of the shaped part according to the invention from FIG. 1a;

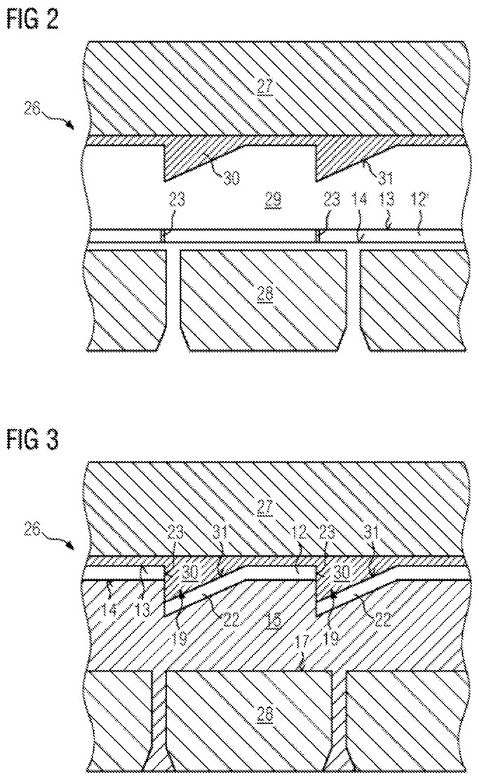

FIG. 2 is a schematic sectional view of a detail of an injection mold for carrying out the method according to the invention for producing a shaped part according to the invention during the production process at a first point in time;

FIG. 3 is a schematic sectional view of a detail of an injection mold for carrying out the method according to the invention for producing a shaped part according to the invention during the production process at a second point in time.

Corresponding parts and components are also identified with the same reference numbers in each of the various embodiments.

FIG. 1a and FIG. 1b show a shaped part 10 according to the invention designed as a decorative and/or lining part for the vehicle interior, with a shaped-part front face 11 designed as a visible face.

The shaped part according to the invention comprises a decorative layer 12 having a front face 13 and a rear face 14 opposite the front face 12, a transparent or translucent substrate 15 made of polycarbonate (PC) located on the rear face 13 of the decorative layer 12, the substrate 15 having a front face 16 and a rear face 17 opposite the front face 16, and a light source 18 located at the rear face 17 of the substrate 15 for shining through the substrate 15 and for illuminating at least a part of the front face 13 of the decorative layer 12.

The substrate 15 has a plurality of recesses 19 on its front face 16, wherein each recess 19 has a bottom face 20 and at least one lateral face 21.

The decorative layer 12 has a number of break portions 22 corresponding to the number of recesses 19, wherein each break portion 22 is at least partially broken out of the decorative layer 12 in the direction of the substrate 15 along provided breaking edges 23, and one break portion 22 is located on the bottom face 20 of each recess 19 so that the at least one lateral face 21 of each recess 19 is exposed and forms a part of the shaped-part front face 11.

Light L emanating from the light source 18 shines through the transparent or translucent substrate 15 and is coupled out of the lateral faces 21 of the recesses 19 to illuminate the front face 13 of the decorative layer 12.

Each of the break portions 22 has three breaking edges 23, wherein each breaking edge 23 completely severs the decorative layer 12.

Alternatively, however, it could also be provided that each of the triangular break portions 22 has two breaking edges 23 each, wherein each breaking edge 23 completely severs the decorative layer 12. In this case, the short side of the triangle would remain on the front face 13 of the decorative layer 12. In addition to triangles, however, various other shapes and patterns are also conceivable.

The plurality of recesses 19 and the corresponding number of break portions 22 form a pattern 24 shown in FIG. 1b on the front face 13 of the decorative layer 12, which pattern creates three-dimensional optical depth effects for an observer on the visible face of the shaped part 10.

The decorative layer 12 can be made of wood or wood veneer or stone or metal, preferably aluminum, or can also be made of plastics material.

The light source 18 is designed as a flat light element, wherein the light element 18 extends completely over the rear face 17 of the substrate 15.

Furthermore, a light barrier (not shown in the drawings) can be provided on the rear face 14 of the decorative layer 12. It can also be provided that a protective and/or optical layer (not shown in the drawings), made of open-pored or high-gloss lacquer, is applied to the front face 13 of the decorative layer 12.

In the following, an embodiment of a method according to the invention for producing a shaped part 10 according to the invention will be described with reference to FIG. 2 and FIG. 3.

First, a decorative material 12′ intended to form the decorative layer 12 is provided. The decorative material 12′ provided for forming the decorative layer 12 is preferably wood or wood veneer or stone or metal, preferably aluminum, or plastics material.

Breaking edges 23 are then produced in the decorative layer 12. The breaking edges 23 are embossed into the decorative material 12 provided for forming the decorative layer 12 by means of an embossing plate, wherein the decorative material 12′ provided for forming the decorative layer 12 is completely severed. After the breaking edges 23 have been produced, the embossing plate is used as an insert 30 for the injection mold 26.

In a further step, an injection mold 26 shown in FIG. 2 and FIG. 3 is provided. This injection mold 26 comprises a first mold half 27 and a second mold half 28 as well as a cavity 29 formed by the two mold halves 27, 28. The insert 30 is located on the first mold half 27. The insert 30 has a negative structure 31 with respect to the recesses 19 to be formed in the substrate 15.

Subsequently, the decorative material 12′ provided for forming the decorative layer 12 is inserted into the injection mold 26 such that the front face 13 of the decorative material 12′ provided for forming the decorative layer 12 is oriented toward the first mold half 27, as shown in FIG. 2.

The injection mold 26 is then closed and a transparent or translucent substrate material, preferably polycarbonate (PC), is injected to form the substrate 15 from the second mold half 28 onto the rear face 17 of the decorative material 12′ provided for forming the decorative layer 12.

When the substrate material is injected, the front face 13 of the decorative material 12′ provided for forming the decorative layer 12 is pressed against the insert 30, and the decorative layer 12 of the shaped part 10 is thus formed in a shape specified by the insert 30 and/or the mold face of the first mold half 27.

Furthermore, the decorative material 12′ provided for forming the decorative layer 12 is broken at the breaking edges 23 by the negative structure 31 of the insert 30 or the mold face of the first mold half 27 in such a way that break portions 22 are formed in the decorative layer 12, wherein each break portion 22 is at least partially broken out of the decorative layer 12 in the direction of the substrate 15 to be formed.

The recesses 19 are formed on the front face 16 of the substrate 15 by the negative structure 31 of the insert 30, wherein each recess 19 has a bottom face 20 and at least one lateral face 21, as shown in FIG. 3.

Furthermore, one break portion 22 of the decorative layer 12 is located on the bottom face 20 of the recesses 19 due to the negative structure 31 of the insert 30, so that the at least one lateral face 21 of each recess 19 is exposed and forms a part of the shaped-part front face 11.

The recesses 19 and the break portions 22 form a pattern 24 specified by the negative mold 31 on the front face 13 of the decorative layer 12. FIG. 1b shows an example of such a pattern 24.

In a further step, the substrate material solidifies. After solidification, the substrate/decorative layer composite that is now formed is removed from the injection mold 26.

Furthermore, a light source 18 for shining through the substrate 15 and for illuminating at least part of the front face 13 of the decorative layer 12 is attached to the rear face 17 of the substrate 15. A flat light element is used as the light source 18, which extends completely over the rear face 17 of the substrate 15.

A light barrier (not shown in the drawings) can also be provided on the rear face 14 of the decorative layer 12. Furthermore, a protective and/or optical layer (not shown in the drawings) made of open-pored or high-gloss lacquer can be located on the front face 13 of the decorative layer 12 after the substrate-decorative layer composite has been produced.

### LIST OF REFERENCE SIGNS

10 Shaped part
11 Shaped-part front face
12 Decorative layer
12 Decorative material
13 Front face
14 Rear face
15 Substrate
16 Front face
17 Rear face
18 Light source
19 Recess
20 Bottom face
21 Lateral face
22 Break portion
23 Breaking edge
24 Pattern
25 Rear face
26 Injection mold
27 First mold half
28 Second mold half
29 Cavity
30 Insert
31 Negative structure
L Light

1. A shaped part having a shaped-part front face designed as a visible face, comprising;
a decorative layer having a front face and a rear face opposite the front face,
a transparent or translucent substrate located on the rear face of the decorative layer, wherein the substrate has a front face and a rear face opposite the front face, and
at least one light source located laterally on or at the rear face of the substrate for shining through the substrate and/or for illuminating at least a part of the front face of the decorative layer,
wherein the substrate has one or more recesses on its front face,
wherein each recess has a bottom face and at least one lateral face,
wherein the decorative layer has a number of break portions corresponding to the number of recesses, wherein each break portion is at least partially broken out of the decorative layer in the direction of the substrate along provided breaking edges, and one break portion is located on the bottom face of each recess so that the at least one lateral face of each recess is exposed and forms a part of the shaped-part front face, and
wherein light (L) emanating from the light source shines through the transparent or translucent substrate and is coupled out of the lateral face or lateral faces of the one or more recesses to illuminate the front face of the decorative layer.

2. The shaped part according to claim 1, characterized in that each break portion has at least one breaking edge, each breaking edge completely severing the decorative layer.

3. The shaped part according to claim 1, characterized in that a plurality of recesses and a corresponding number of break portions are provided, the recesses and/or break portions forming a pattern on the front face of the decorative layer.

4. The shaped part according to claim 1, characterized in that:
the decorative layer is made of wood and/or wood veneer and/or stone and/or metal and/or plastics material, or
in that the decorative layer comprises wood and/or wood veneer and/or stone and/or metal and/or plastics material.

5. The shaped part according to claim 1, characterized in that the light source is or comprises a flat or partially flat light element, the light element extending at least in portions over the rear face of the substrate.

6. The shaped part according to claim 1, characterized in that:
a light barrier is provided on the rear face of the decorative layer, and/or
in that a protective and/or optical layer is located on the front face of the decorative layer.

7. A method for producing a shaped part, comprising the steps of:
providing a decorative material intended to form the decorative layer;
creating breaking edges in the decorative layer;
providing an injection mold, comprising at least a first mold half and a second mold half as well as a cavity formed by the two mold halves, wherein an insert having a negative structure with respect to one or more recesses to be formed in the substrate is located on the first mold half, or wherein the first mold half has a mold face with a negative structure with respect to one or more recesses to be formed in the substrate;
inserting the decorative material provided for forming the decorative layer into the injection mold in such a way that the front face of the decorative material provided for forming the decorative layer is oriented toward the first mold half;
closing the injection mold;
injecting a transparent or translucent substrate material to form the substrate from the second mold half onto the rear face of the decorative material provided for forming the decorative layer,
wherein the front face of the decorative material provided for forming the decorative layer is pressed against the insert or the mold face of the first mold half and the decorative layer of the shaped part is thus formed in a shape specified by the insert and/or the mold face of the first mold half, and
wherein the decorative material provided for forming the decorative layer is broken at the breaking edges by the negative structure of the insert or the mold face of the first mold half in such a way that break portions are formed in the decorative layer,
wherein each break portion is at least partially broken out of the decorative layer in the direction of the substrate to be formed,
wherein a recess is formed by the negative structure of the insert or the mold face of the first mold half on the front face of the substrate in the region of each break portion, each recess having a bottom face and at least one lateral face,
wherein one break portion is located on the bottom face of each recess due to the negative structure of the insert or the mold face of the first mold half, so that the at least one lateral face of each recess is exposed and forms a part of the shaped-part front face;
solidifying the substrate material and removing the substrate-decorative layer composite from the injection mold;
locating a light source for shining through the substrate and/or for illuminating at least part of the front face of the decorative layer laterally on the substrate or on the rear face of the substrate.

8. The method according to claim 7, characterized in that the breaking edges are produced by means of an embossing plate before injection molding in the decorative material provided for forming the decorative layer.

9. The method according to claim 8, characterized in that the embossing plate is used as an insert for the injection mold after the breaking edges have been produced.

10. The method according to claim 7, characterized in that the breaking edges are produced by the insert or the mold face of the first mold half during injection molding in the decorative material provided for forming the decorative layer.

11. The method according to claim 7,
characterized in that a plurality of recesses and a corresponding number of break portions are provided, the recesses and/or break portions forming an intended pattern on the front face of the decorative layer.

12. The method according to claim 7,
characterized in that:
a light barrier is provided on the rear face of the decorative layer, and/or
in that a protective and/or optical layer is located on the front face of the decorative layer after the substrate-decorative layer composite has been produced.
